(19) United States
(12) Patent Application Publication
(10) Pub. No.: US 2005/0219227 A1
(43) Pub. Date: Oct. 6, 2005

(54) User interface device executing selection and registration of two-dimensionally arranged options and associated image forming apparatus

(75) Inventors: Taketoshi Yamahata, Toyokawa-shi (JP); Kenichi Matsumoto, Toyokawa-shi (JP); Masahiro Imamura, Toyokawa-shi (JP); Tsuyoshi Yoneyama, Tokyo (JP); Hideyuki Hashimoto, Toyokawa-shi (JP)

Correspondence Address: Barry E. Bretschneider;Morrison & Foerster LLP, Suite 300, 1650 Tysons Boulevard, McLean, VA, 22102, US

(73) Assignee: Konica Minolta Business Technologies, Inc., Chiyoda-ku (JP)

(21) Appl. No.: 11/008,740

(22) Filed: Dec. 10, 2004

(30) Foreign Application Priority Data
Mar. 30, 2004 (JP) 2004-98598
Apr. 19, 2004 (JP) 2004-122856

(51) Int. Cl. G09G 5/00

(52) U.S. Cl. 345/173

(57) ABSTRACT

In order to provide a user interface device that can realize a superior user interface during selection of a one-touch area for settings information new registration, update registration or retrieval operations, a user interface device is provided that includes a display that displays screens containing various types of information and switches and displays in an alternating fashion multiple selection screens in which multiple options are shown at predetermined positions, such apparatus further having a position designating unit that designates a position of an option as well as a display controller that performs-control such that the option located at the position designated by the position designating unit in each of the multiple selection screens is displayed on the display.

This application is based on Japanese Patent Application (s) No(s). 2004-098598 filed in Japan on Mar. 30, 2004 and 2004-122856 filed in Japan on Apr. 19, 2004, the entire content of which is hereby incorporated by reference.

### BACKGROUND OF THE INVENTION

1. Field of the Invention

The present invention relates to a user interface device that includes display means that displays screens containing various types of information, wherein multiple selection screens in each of which multiple options are arranged such that they reside at predetermined positions are switched in an alternating fashion and displayed on such display means, as well as to an image forming apparatus in which such user interface device is installed.

2. Description of Related Art

As known in the conventional art, information processors—such as printers, facsimile machines, copying machines, or MFPs (Multifunction Peripherals) that combine the functions of a printer, a facsimile machine and a copying machine—include a function by which frequently used information is registered in advance such that it can be retrieved and set at the time of use, for example. Using this function, the user can retrieve registered information simply by inputting a prescribed number without needing to input a fax number, e-mail address or print setting values each time he wishes to send a facsimile or e-mail or print, which simplifies the data setting operation. In order to allow registration of multiple sets of settings information, multiple memory areas that individually store settings information (hereinafter ‘one-touch areas’) are usually created in a memory. Such a one-touch registration function is disclosed in Japanese Laid-Open Patent Application 2001-223869, for example.

Incidentally, in an information processor, when a one-touch area is to be selected for new registration, update registration or retrieval of one-touch data, the available one-touch areas are generally displayed using a GUI to enable user interface, as in the case in which each one-touch area is represented by one key (button) on the display panel of the operation unit included in the processor. However, the number of one-touch areas that can be displayed in one screen is limited by the size of the operation panel. In order to resolve this problem, a method widely used in the conventional art uses multiple screens (so-called indices) that include a prescribed number of keys corresponding to the available one-touch areas, such that any of such areas can be selectively displayed on the display panel in an alternating fashion.

However, when selecting a one-touch area during new registration, update registration or retrieval of settings information, it is very cumbersome to seek the desired one-touch area by switching among the multiple indices. In recent years, the number of registrations based on the one-touch function has tended to increase, and there is a concern accordingly that the search operation will become even more cumbersome. In order to mitigate the cumbersome nature of the search operation, it is necessary to devise a new specification for the display of one-touch areas on the display panel of the operation unit.

### OBJECT AND SUMMARY

An object of the present invention is to provide an improved user interface device that resolves the various problems identified above, as well as an image forming apparatus in which such user interface device is installed.

Another object of the present invention is to provide a user interface device that can achieve a superior user interface for selection of a one-touch area for new registration, update registration or retrieval of settings information, as well as an image forming apparatus in which such user interface device is installed.

These objects are attained by a user interface device, comprising: a display that displays a plurality of first selection screens, each of which includes a plurality of options positioned at predetermined positions, alternatively; a position designation unit that designates a position of an option; and a display controller that controls the display so that a second selection screen is displayed on the display, wherein the second selection screen includes options located at the position designated by the position designation unit in each of the plurality of the first selection screens.

It is preferred that the user interface device further comprising, a selection unit that selects a desired option, which is at least one of the options of the second selection screen.

It is preferred that the user interface device, wherein the display controller controls the display so that when the desired option is selected by the selection unit, a settings information corresponding to the desired option is displayed on the display.

It is preferred that the user interface device further comprising, a storage unit that stores settings information in connection with each of the plurality of the options.

It is preferred that the user interface device according to claim 1, further comprising, a storage unit that stores settings information in connection with each of the plurality of the options, and a selection unit that selects a desired option, which is at least one of the options of the second screen, wherein the display controller control the display so that the settings information corresponding to the desired option selected by the selection unit is displayed on the display.

It is preferred that the user interface device further comprising an update unit that updates the settings information corresponding to the desired option displayed by the display controller.

It is preferred that the user interface wherein for selecting the desired option the user interface has a first mode in which the desired option is selected from the first selection screen and a second mode in which the desired option is selected from the second selection screen.

It is preferred that the user interface device, wherein the display controller controls the display so that a position designation screen which represented the number of options or a graphic symbol representing such number at the position corresponding to each position of the plurality of options included in each selection screens located therein is displayed on the display, and wherein the position designation unit designates a position of the option form the position designation screen.

From another perspective, the above objects are attained by a user interface device, comprising: a display that displays a plurality of fist selection screens, each of which includes a plurality of options positioned at predetermined positions, alternatively; a storage unit that stores settings information in connection with each of the plurality of the options, a position designating unit that designates a position of an option, a display controller that controls the display so that a input screen, which is accepted the registration of new settings information in connection with the non-registration option, is displayed on the display, wherein the non-registration option is one of the options which is located at the position designated by the position designation unit in each of the plurality of the selection screens, and to which the settings information in connection with the non-registration option is not registered in the storage unit; and an input unit for inputting the new settings information in the input screen.

From another perspective, the above objects are attained by a user interface device, comprising: a display that displays a plurality of first selection screens, each of which includes a plurality of options positioned at predetermined positions, alternatively; a storage unit that stores settings information in connection with each of the plurality of the options; a mode selecting unit that selects either a registration mode for the registration of new settings information or a confirmation mode for confirming already registered settings information; a position designation unit that designates the position of a option, a display controller that controls the display, so that a second selection screen, which includes options located at the position designated by the position designation unit in each of the plurality of the first selection screen, is displayed on the display, in a case where the registration mode is selected, and so that a input screen, which is accepted the registration of new settings information in connection with the non-registration option, is displayed on the display, in a case where the registration mode is selected, wherein the non-registration option is one of the options which is located at the position designated by the position designation unit in each of the plurality of the selection screens, and to which the settings information in connection with the non-registration option is not registered in the storage unit; an input unit for inputting the new settings information in the input screen, and a selection unit that selects a desired option, which is at least one of the options of the second screen; wherein the display controller controls the display so that when the desired option is selected by the selection unit, a settings information corresponding to the desired option is displayed on the display.

From another perspective, the above objects are achieved by a user interface device, comprising: a display that displays a plurality of selection screens, each of which includes a plurality of options positioned at predetermined positions, alternatively; a storage unit that stores settings information in connection with each of the plurality of the options; and a display controller that controls the display so that a position designation screen which represented the number of options or a graphic symbol representing such number at the position corresponding to each position of the plurality of options included in each selection screens located therein is displayed on the display.

From another perspective, the above objects are achieved by a user interface device, comprising: a display that displays a plurality of selection screens, each of which includes a plurality of options positioned at predetermined positions, alternatively; a storage unit that stores settings information in connection with each of the plurality of the options, a position designating unit that designates a position of an option, and a display controller that controls the display so that a registration confirmation screen is displayed on the display, wherein the registration confirmation screen corresponds to a selection screen that includes a non-registration option located at the position designated by the position designation unit and the settings information in connection with the non-registration option is not registered in the storage unit.

It is preferred that the user interface device wherein when settings information is registered in connection with all of the options, which is located at the position designated by the position designation unit, in the plurality of selection screens, the registration confirmation screen corresponds to a new selection screen different from the plurality of selection screens.

It is preferred that the user interface device further comprising: an approval unit that approves the non-registration option displayed on the registration confirmation screen when the non-registration option is acceptable for the registration of settings information; and an input unit by which to input settings information for registration, wherein when approval is input by the approval input unit, the display controller performs control so that a settings input screen that accepts new registration information is displayed on the display.

From another perspective, the above objects are attained by a user interface device, comprising: a display that displays a plurality of selection screens, each of which includes a plurality of options positioned at predetermined positions, alternatively; a storage unit that stores settings information in connection with each of the plurality of the options, an input unit by which to input settings information for registration, a position designating unit that designates a position of an option, and a controller that controls so that the settings information inputted by the input unit is stored in connection with the non-registration option, when the non-registration option, which is located at the position designated by the position designation unit and to which the settings information is not registered, exists and so that the settings information inputted by the input unit is stored in connection with a new option in a new selection screen, when all of the options in the plurality of selection screens located at the position designated by the position designation unit have registered settings information.

It is preferred that the user interface device wherein the display is controlled so that where the settings information is registered with the option in a new selection screen, the plurality of selection screens including the new selection screen are displayed in an alternating fashion.

It is preferred that the user interface device according to claim 15, further comprising: a mode selection unit for selecting a first mode and a second mode, wherein the first selection mode in which a desired option is selected from among the options in the plurality of selection screens located at the position designated by the position designating unit, and wherein the second selection mode in which a desired option is selected from among the options displayed in a desired selection screen displayed by switching among the plurality of selection screens.

From another perspective, the above objects are attained by an image forming apparatus, comprising: a display that displays a plurality of selection screens, each of which includes a plurality of options positioned at predetermined positions, alternatively; a position designation unit that designates a position of an option; an extraction portion that extracts extraction options located at the position designated by the position designation unit in each of the plurality of the selection screens; and a display controller that controls the display so that a extraction screen which represented the extraction options is displayed on the display.

Using the constructions described above, according to the present invention, display keys corresponding to groups of registration areas are displayed at specific positions on a screen and selection of a registration area is enabled thereby, taking advantage of the user tendency to recognize the registration area in which he registered settings information as positional information on the display. As a result, it is no longer necessary to switch among multiple available screens, such as where an index-based display specification is used, and a superior user interface can be realized.

Furthermore, according to one aspect of the present invention, by ensuring the availability of a registration area in which settings information can be registered in connection with a key located at a specific position selected by the user so long as the registration upper limit tolerated by the storage means that records settings information is not exceeded, the user can very easily select a one-touch area and a superior user interface can be realized. In this case, the user does not need to re-select a key located at a different specific position on a screen of the display means, so that the user's tendency to recognize the location of settings information registration (i.e., a registration area) as positional information on the display means can be more effectively utilized.

### BRIEF DESCRIPTION OF THE DRAWINGS

These and other objects and features of the present invention will become clear from the following description taken in conjunction with the preferred embodiments thereof with reference to the accompanying drawings, in which:

FIG. 1 is a block diagram showing the basic construction of an MFP pertaining to an embodiment of the present invention;

FIG. 2 shows the operation unit of the MFP displaying a one-touch area selection screen of the conventional art in which one-touch area designation keys are displayed for each index on the display panel;

FIG. 3 shows the display panel displaying an information display screen containing the information registered for one one-touch area;

FIG. 4 shows a display panel displaying a new one-touch area selection screen pertaining to an embodiment of the present invention;

FIG. 5 shows the display panel displaying a one-touch data list screen in response to the selection of a group designation key on the one-touch area selection screen shown in FIG. 4;

FIG. 6 shows the display panel displaying the one-touch area selection screen after a one-touch data set is newly registered in the state shown in FIG. 4;

FIG. 7 is a flow chart of a one-touch data new registration process based on the new one-touch area selection screen;

FIG. 8 is a flow chart of a one-touch data update registration process based on the new one-touch area selection screen;

FIG. 9 is a flow chart of a one-touch data retrieval process based on the new one-touch data selection screen;

FIG. 10(a) shows the display panel displaying a new one-touch area selection screen in which one of the group designation keys is selected for new registration, and FIG. 10(b) shows the display panel displaying a registration area confirmation screen when an unregistered one-touch area exists in connection with the selected group designation key;

FIG. 11(a) shows the display panel displaying a new one-touch area selection screen in which one of the group designation keys is selected for new registration, FIG. 11(b) shows the display panel displaying a registration area confirmation screen when an unregistered one-touch area does not exist in connection with the selected group designation key but an unregistered one-touch area exists in connection with a different group designation key (this registration area confirmation screen has an additionally created index that corresponds to the selected group designation key), and FIG. 11(c) shows the display panel displaying a one-touch area selection screen in which the one-touch area used in the additional creation of an index and a one-touch area belonging thereto are disabled from selection;

FIG. 12(a) shows the display panel displaying a new one-touch area selection screen in which one of the group designation keys is selected, and FIG. 12(b) shows the display panel displaying a message informing the user that new registration is not enabled when no unregistered one-touch areas exist either in connection with the selected group designation key or other group designation keys; and

FIG. 13 is a flow chart of a one-touch data update registration process based on the new one-touch area selection screen that includes the process pertaining to this embodiment to create an additional index.

### DETAILED DESCRIPTION OF THE PREFERRED EMBODIMENTS

Embodiments of the present invention are described below with reference to the accompanying drawings.

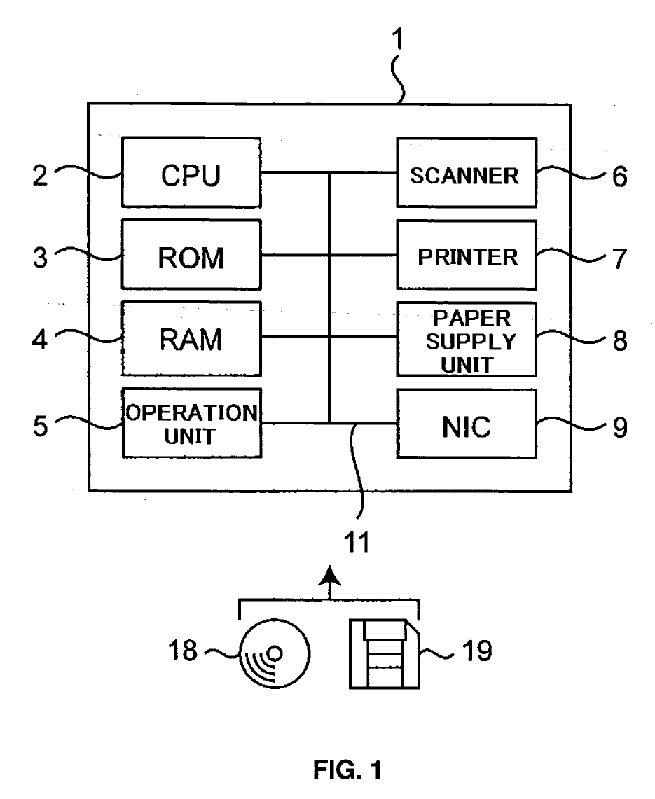

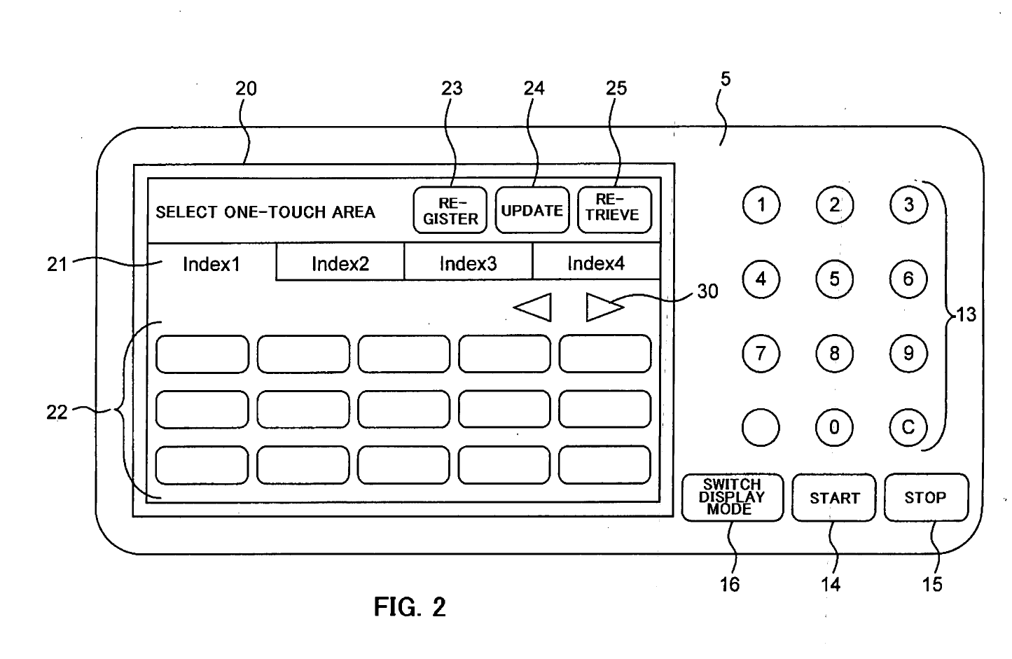

FIG. 1 is a block diagram showing the basic construction of an MFP pertaining to an embodiment of the present invention. The MFP 1 has a CPU 2 that executes sequence control regarding the various components of the MFP 1 by causing them to carry out various commands based on a prescribed program, a ROM 3 that stores the program on which the sequence control executed by the CPU 2 is based, a RAM 4 that is consisted of a volatile memory which serves as a work area necessary for the execution of such program, temporarily stores print job data sent from external devices, and non-volatile memory which stores various settings information entered by the user for use by the one-touch registration function or job memory function, for example, an operation unit 5 that enables operation of the device by the user as well as the input of various settings information (the details of which are described below with reference to FIG. 2), a scanner 6 that reads original documents and obtains bitmap image data, for example, a printer 7 that executes printing on paper based on print job data, a paper supply unit 8 that supplies paper to the printer 7, and a network interface card (‘NIC’ in the drawing) 9 used to send and receive various data such as print job data to and from external devices. These components are interconnected via a bus 11 such that data can be sent and received to and from each of the various devices.

In this embodiment, the program on which the sequence control executed by the CPU 2 is based is stored in the ROM 3 of the MFP 1, for example, but the program may be stored in an external storage medium such as a CD-ROM 18, a floppy® disk 19 or the like and loaded where necessary via a CD-ROM or floppy disk drive (not shown) that is externally mounted to the MFP 1.

This MFP 1 has a generally known one-touch registration function by which frequently used information registered in advance is retrieved and set at the time of use, for example. Multiple areas (hereinafter ‘one-touch areas’) to each of which is assigned a specific number (hereinafter ‘one-touch number’) are created in the RAM 4 in order to enable registration of multiple sets of settings information. Settings information such as a fax or e-mail recipient's name, a fax number, an e-mail address or printing parameter values (hereinafter ‘one-touch data’) is stored in each one-touch area in a mutually associated manner.

In this embodiment, operations such as new registration, updating or retrieval of one-touch data can be performed not only by using the operation unit 5 of the MFP 1 but also over the Web or via e-mail using an external terminal (not shown) connected to the MFP 1, but in the description below, a situation in which these operations are performed using the operation unit 5 of the MFP 1 will be used as an example.

FIG. 2 is a drawing showing the operation unit 5 of the MFP 1. This operation unit 5 has input buttons 13 that include a numeric keypad by which to enter the number of copies to print, the password and the like and a clear button by which to change the settings information such as the number of copies to print, a start button 14 by which to commence the various functions, a stop button 15 by which to stop the various functions, and a touch-panel display panel 20 that displays screens that contain various types of information.

The operation unit 5 actually includes other components such as a function switching button by which to select the printing, copying or fax function and a panel reset button, but these other components are omitted from this description. In addition, the input keys 13, start button 14, stop button 15 and the like are mechanical buttons, but the present invention is not limited to this implementation, and they may comprise display keys that are shown on the screen of the display panel 20.

In FIG. 2, a conventional one-touch area selection screen (initial screen) is displayed on the display panel 20. In other words, this screen includes multiple index tags 21, and by selecting an index tag 21, keys (hereinafter ‘one-touch area designation keys’) 22 that respectively correspond to the one-touch areas belonging to that index are displayed. In the state shown in FIG. 2, the index tag Index 1 is selected, and 15 (3×5) one-touch area designation keys 22 corresponding to the one-touch areas belonging to Index 1 are being displayed.

Although Index 1 through Index 4 are shown as the index tags 21 in FIG. 2, more index tags 21, i.e., Index 5 and onward, exist in actuality. Therefore, the display screen shown in FIG. 2 includes shift keys 30, and by pressing these keys, the index tags displayed shift sequentially to enable the desired index tags to be displayed.

The one-touch area designation keys 22 belonging to each index respectively correspond to specific one-touch numbers assigned to the one-touch areas. In the display screen shown in FIG. 2, 15 one-touch area designation keys 22 arranged in a 3×5 matrix belonging to Index 1 respectively correspond to one-touch numbers 1-15. More specifically, the one-touch area designation keys 22 in the upper row respectively correspond to the one-touch numbers 1-5 from the left, the one-touch area designation keys 22 in the middle row respectively correspond to the one-touch numbers 6-10 from the left, and the one-touch area designation keys 22 in the bottom row respectively correspond to the one-touch numbers 11-15 from the left.

The one-touch area designation keys 22 corresponding to these one-touch numbers 1-15 are always shown at the same locations each time the index tag Index 1 is selected. In order to realize this arrangement, the display screen in which the one-touch area designation keys 22 are located has specific positions 1-15. In other words, the one-touch area designation keys 22 corresponding to the one-touch numbers 1-15 are respectively assigned to the specific positions 1-15. These specific positions 1-15 remain fixed regardless of which index tag is selected, and the 15 one-touch area designation keys 22 are respectively positioned so as to match the corresponding specific positions 1-15.

As a result, it can be seen that the relationship governing the one-touch number X, the specific position (n) and the index number (m) is expressed by the following mathematical formula.
X=n+15×(m−1)

According to this mathematical formula, the one-touch number corresponding to the one-touch area designation key 22 located in the center of the middle row, i.e., at the specific position 8, for Index 4 is expressed as shown below.
X=8+15×(4−1)=53

The one-touch number corresponding to the one-touch area designation key 22 constituting the rightmost key of the bottom row, i.e., at the specific position 15, for Index 8 is expressed as shown below.
X=15+15×(8−1)=120

Furthermore, the display screen shown in FIG. 2 includes keys 23, 24 and 25 by which to select ‘register’, ‘update’ or ‘retrieve’ prior to the selection of a one-touch area. ‘Register’ refers to the registration of one-touch data in connection with an unused one-touch area, ‘update’ refers to the overwriting of one-touch data already registered to a one-touch area, and ‘retrieve’ refers to the retrieval and setting of the one-touch data already registered to a one-touch area at the time of use of the MFP 1.

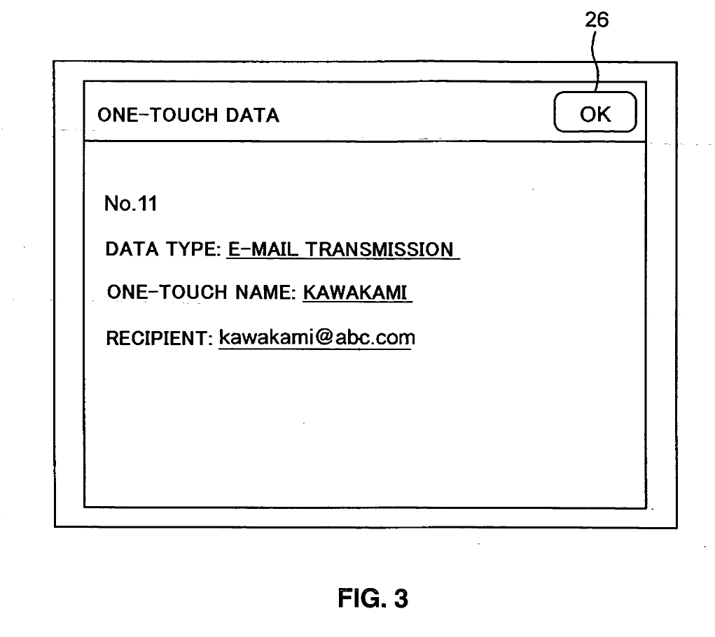

In the conventional one-touch area selection screen shown in FIG. 2, when the register key 23, update key 24 or retrieve key 25 is selected, the one-touch area designation keys 22 that are displayed at that time become enabled for selection. When one of the one-touch area designation keys 22 is then selected, the screen shown in FIG. 3 is displayed on the display panel 20. In this example, the one-touch area corresponding to the one-touch number ‘11’ is selected in the one-touch area selection screen of FIG. 2, and the screen that corresponds to that one-touch area is displayed in FIG. 3. This screen includes as information items that can be registered in the one-touch area ‘data type’ that designates the data transmission format (fax transmission or e-mail transmission) for transmission of data using the one-touch data, ‘one-touch name’ indicating the recipient's name, and ‘recipient’. In the state shown in FIG. 3, ‘e-mail transmission’, ‘Kawakami’ and ‘kawakami@abc.com’ are set for these information items.

Strictly speaking, when the register key 23 is selected, no settings have been input for the information items in the screen shown in FIG. 3, such that empty spaces are displayed for ‘data type’, ‘one-touch name’, and ‘recipient’. The user can input the one-touch data to be registered in these spaces. When the update key 24 is selected, the one-touch data that is already registered for each information item is displayed in the screen shown in FIG. 3, such that the user can overwrite it with new one-touch data to be registered. When the retrieve key 25 is selected, the one-touch data that is already registered is displayed in the screen shown in FIG. 3, and overwriting is not enabled.

The screen shown in FIG. 3 also includes an OK key 26. When the register key 23 or the update key 24 is selected, if the user touches the OK key 26 upon the completion of input of settings information, data registration becomes completed. When the retrieve key 25 is selected, if the user touches the OK key 26 upon the confirmation of the displayed one-touch data, data setting becomes completed.

In the description below, in order to distinguish between a situation in which input of settings information is enabled and a situation in which it is not enabled, the FIG. 3 screen that is shown when the register key 23 or the update key 24 is selected will be referred to as the ‘settings input screen’, and the FIG. 3 screen that is shown when the retrieve key 25 is selected will be referred to as the ‘one-touch data confirmation screen’.

Incidentally, according to a test carried out by the inventors of the present invention, it is known that the user tends to recognize a one-touch area to which he registered one-touch data based not on the one-touch number assigned thereto, but as positional information on the display panel 20. In this embodiment, in order to realize a superior user interface in the selection of a one-touch area, a new one-touch area selection screen having display specifications that take advantage of such a user tendency is adopted. As shown in FIG. 2, the operation unit 5 of the MFP 1 includes a display mode switching button 16 by which to alternate the display specifications for the one-touch area selection screen displayed on the display panel 20, such that the user can easily switch from the conventional one-touch area selection screen shown in FIG. 2 to the new one-touch area selection screen and vice versa by pressing the display mode switching button 16. The new one-touch area selection screen will be described below.

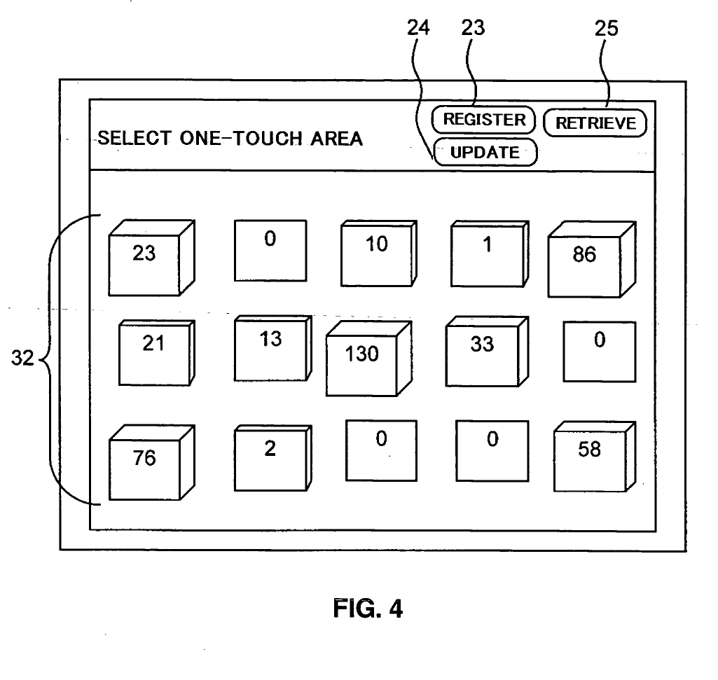

FIG. 4 shows the new one-touch area selection screen displayed on the display panel 20. In this embodiment, in order to construct this new one-touch area selection screen, the multiple one-touch areas created in the RAM 4 are divided into 15 groups and assigned to specific positions 1-15 that are arranged in the same manner as the specific positions to which the one-touch area designation keys 22 explained with reference to FIG. 2 are assigned. Group designation keys 32 that correspond to each group are assigned to the specific positions 1-15 arranged on the display screen. In other words, according to the display specification of the screen shown in FIG. 4, M one-touch area designation keys 22 located at the same position and displayed for each index tag Index 1-M (M being the largest index number) in the screen shown in FIG. 2 are overlapped at each of the 15 locations, and a group designation key 32 is assigned to each such group of overlapped keys.

In the screen shown in FIG. 4, the group designation keys 32 are displayed three-dimensionally in the form of boxes such that each of them shows the registration status of the one-touch areas belonging to the group that the key represents, i.e., each box has a depth that corresponds to the number of one-touch areas that already have registered data, and the number of registrations is numerically indicated. Specifically, the group designation key 32 in the center of the middle row, i.e., the group designation key 32 at the specific position 8, is displayed three-dimensionally having considerable depth, and the number of registrations ‘130’ is shown thereon. Because the group represented by the group designation key 32 at the center of the bottom row, i.e., the group designation key 32 at the specific position 13, has no one-touch areas containing registered information, it is displayed flat without any depth, and the number of registrations ‘0’ is displayed thereon. The display format for the group designation keys 32 is not limited to this implementation. It is acceptable if the keys have no depth and are shown simply as rectangular frames without the indication of the number of registrations. Alternatively, only numeric information representing the number of registrations may be displayed in rectangular frames.

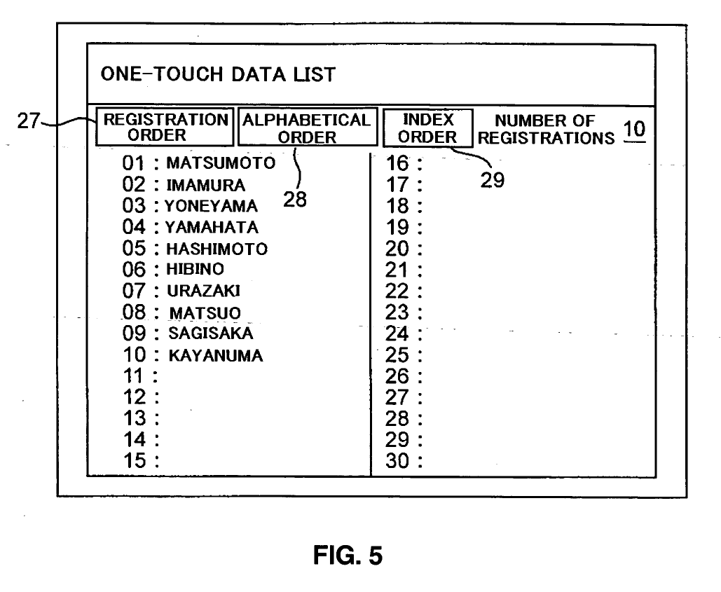

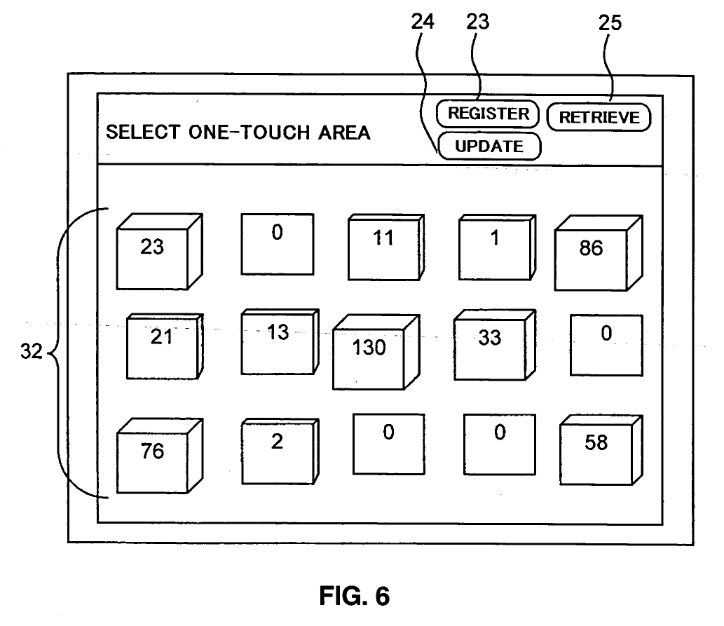

The screen shown in FIG. 4 includes a register key 23, update key 24 and retrieve key 25, as in the case of the conventional one-touch area selection screen shown in FIG. 2, and when one of these keys is selected, selection of the group designation keys 32 becomes enabled. When one of the group designation keys 32 is thereafter selected, a different screen is displayed on the display panel 20. This screen displayed upon the selection of a group designation key 32 varies, however, depending on which of the register key 23, update key 24 or retrieve key 25 was selected.

Where one of the group designation keys 32 is selected after the register key 23 is selected, a search for a one-touch area that contains no registered data (‘unregistered one-touch area’) is begun with regard to the one-touch areas that belong to the group corresponding to the selected group designation key 32 at the time of such selection. One of the unregistered one-touch areas obtained as a result of the search (the one-touch area having the smallest one-touch number, for example) is automatically selected, and the settings input screen as shown in FIG. 3 is displayed for such one-touch registration area without any entered data. Namely, the screen is displayed with blank spaces for ‘data type’, ‘one-touch name’ and ‘recipient’. The user inputs one-touch data to register in these blank spaces, and when the user touches the OK key 26 at the upper right corner of the screen, new registration is completed.

Where the group designation keys 32 are displayed with depth and contain the number of registered one-touch areas for that key in order to indicate the state of registration in each group, the display of the group designation keys 32 changes after new registration is completed. For example, in the state shown in FIG. 4, the number of one-touch area registrations for the group designation key 32 located at the specific position 3 is ‘10’. Where this group designation key 32 is selected in this state and one-touch data is newly registered with a unregistered one-touch area, the one-touch area selection screen displayed after such new registration resembles the screen shown in FIG. 6. In other words, the number of registrations assigned to the group designation key 32 at the specific position 3 is changed from ‘10’ to ‘11’.

Where one of the group designation keys 32 is selected after the update key 24 is selected, a one-touch data list screen that shows the registration status for the one-touch areas belonging to the group corresponding to the selected group designation key 32 is displayed at the time of such selection (see FIG. 5). In this on-touch data list screen, a one-touch data set (in FIG. 5, the ‘one-touch name’ data, which is one of the one-touch data items) comprising data actually registered to the registered one-touch areas, is displayed in a list format according to a prescribed list order. As the list order, ‘order of registration’, by which the data is listed according to the time of registration, ‘alphabetical order’, by which listing is performed alphabetically based on the names, and ‘order of index number’, using which listing begins with the smallest index number, are available, and the screen shown in FIG. 5 includes a registration order selection key 27, alphabetical order selection 28 and index order selection key 29 accordingly. When updating, selection is made by directly touching one of the displayed one-touch data sets. When a one-touch data set is selected, a settings input screen such as that shown in FIG. 3 is displayed. This settings input screen displays the one-touch data that is already registered with regard to each data item, but the user can input new one-touch data to overwrite the existing data. When the user inputs replacement one-touch data for overwriting and touches the OK key 26 in the upper right-hand of the screen, updating is completed.

Where one of the group designation keys 32 is selected after the retrieve key 25 is selected, the one-touch data list screen that shows the status of registration regarding the one-touch areas belonging to the group corresponding to the selected group designation key 32 is displayed at the same time as such selection (see FIG. 5). This is the same one-touch data list screen as described above. For retrieval, a one-touch data set is selected by touching one of the one-touch data sets displayed on the screen. When a one-touch data set is selected, a one-touch data confirmation screen such as that shown in FIG. 3 is displayed. In this one-touch data confirmation screen, the one-touch data that is already registered with regard to each data item is displayed, and the user cannot overwrite this data with new one-touch data. When the user confirms the displayed one-touch data and touches the OK key 26 in the upper right-hand corner of the screen, retrieval is completed.

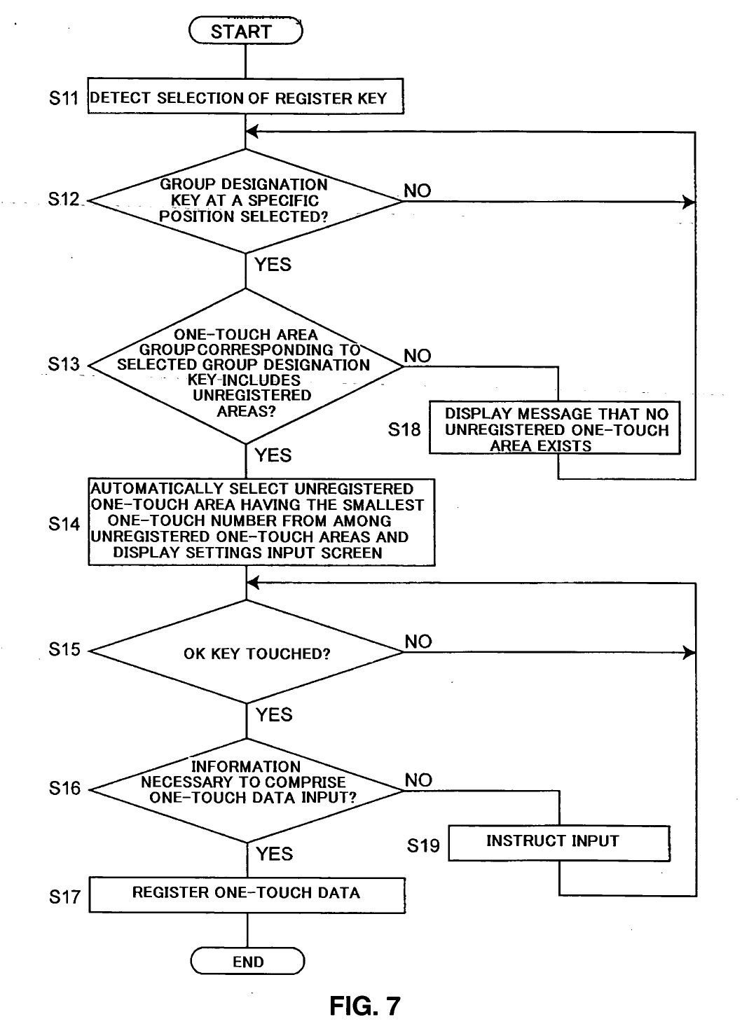

The processes executed by the MFP 1 for new registration, update registration and retrieval based on the new one-touch area selection screen of this embodiment will now be described with reference to FIGS. 7 through 9. FIG. 7 is a flow chart showing the one-touch data new registration process when carried out via the new one-touch area selection screen. In this process, when it is first detected that the register key 23 is selected (S11), it is determined whether or not a group designation key 32 at a specific position is selected (S12). If it is determined that no group designation key 32 is selected, the determination of S12 is carried out once more. On the other hand, if it is determined that a group designation key 32 is selected, it is determined whether or not any unregistered one-touch areas exist in the group of one-touch areas corresponding to the selected group designation key 32 (S13).

If it is determined in S13 that no unregistered one-touch area exists, the user is notified of this fact by a message displayed on the display panel 20, for example (S18). S12 is then returned to, and the operation of S12 as well as subsequent operations are repeated. On the other hand, if it is determined in S13 that one or more unregistered one-touch areas exist, the one-touch area having the smallest one-touch number is selected from among such unregistered one-touch areas, and a settings input screen therefor is displayed (S14).

After S14, it is determined whether or not the OK key 26 has been touched (S15). If it is determined that the OK key 26 has not been touched, the determination of S15 is carried out once more, while if it is determined that the OK key 26 has been touched, it is determined whether or not information necessary to comprise one-touch data has been input via the settings input screen as shown in FIG. 3. If it is determined that the necessary information has not been input, the user is instructed to perform an input operation via a message prompting input that is displayed on the display panel 20, for example (S19), and S15 is returned to. The operation of S15 as well as the subsequent operations are then repeated. On the other hand, if it is determined in S16 that necessary information has been input, such information comprising one-touch data is registered (S17) and the process ends.

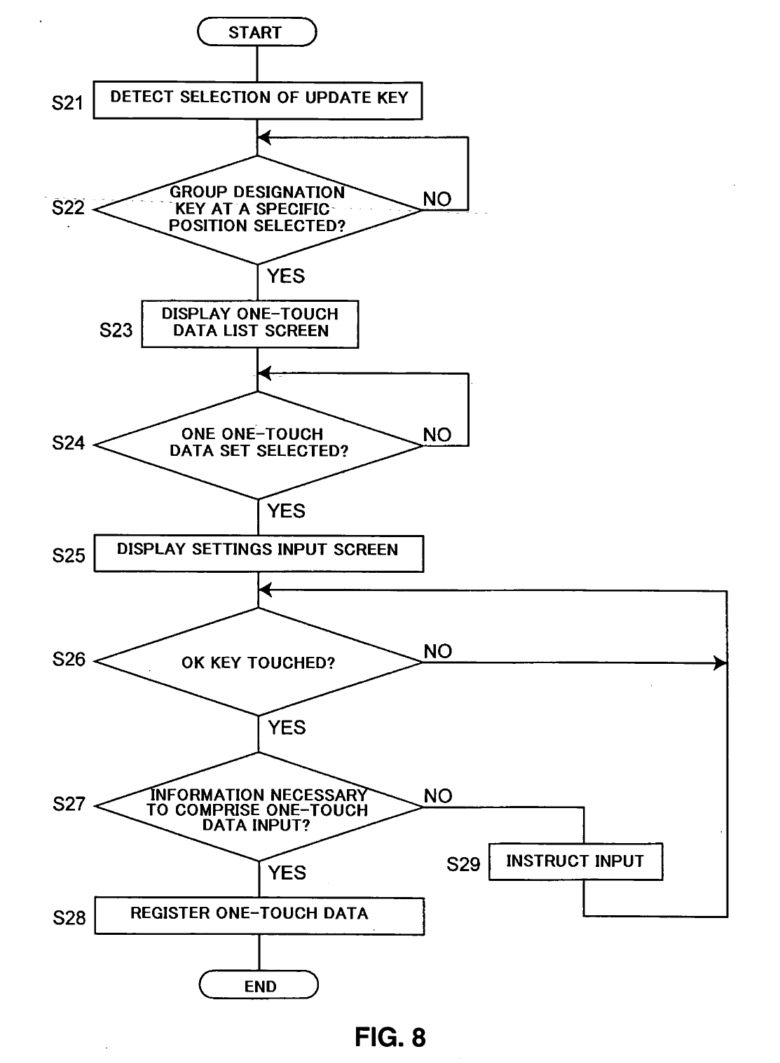

FIG. 8 is a flow chart showing the one-touch data update registration process carried out from the new one-touch area selection screen of this embodiment. In this process, when it is first detected that the update key 24 is selected (S21), it is determined whether or not a group designation key 32 at a specific position is selected (S22). If it is determined that no group designation keys 32 are selected, the determination of S22 is carried out once more. On the other hand, if it is determined that a group designation key 32 is selected, a one-touch data list screen as shown in FIG. 5 is displayed (S23).

It is then determined whether or not a one-touch data set is selected on the one-touch data list screen (S24). If it is determined that no one-touch data set is selected, the determination of S24 is repeated. On the other hand, if it is determined that a one-touch data set is selected, a settings input screen therefore is displayed (S25). It is then determined whether or not the OK key 26 has been touched (S26). If it is determined that the OK key 26 has not been touched, the determination of S26 is carried out once more, while if it is determined that the OK key 26 has been touched, it is determined whether or not the information necessary to comprise one-touch data has been input in the settings input screen as shown in FIG. 3 (S27). If it is determined that the necessary information has not been input, the user is instructed to perform an input operation via a message prompting input that is displayed on the display, for example (S29), and S26 is returned to. The operation of S26 as well as the subsequent operations are then repeated. On the other hand, if it is determined in S27 that the necessary information has been input, such information comprising one-touch data is registered (S28), whereupon the process ends.

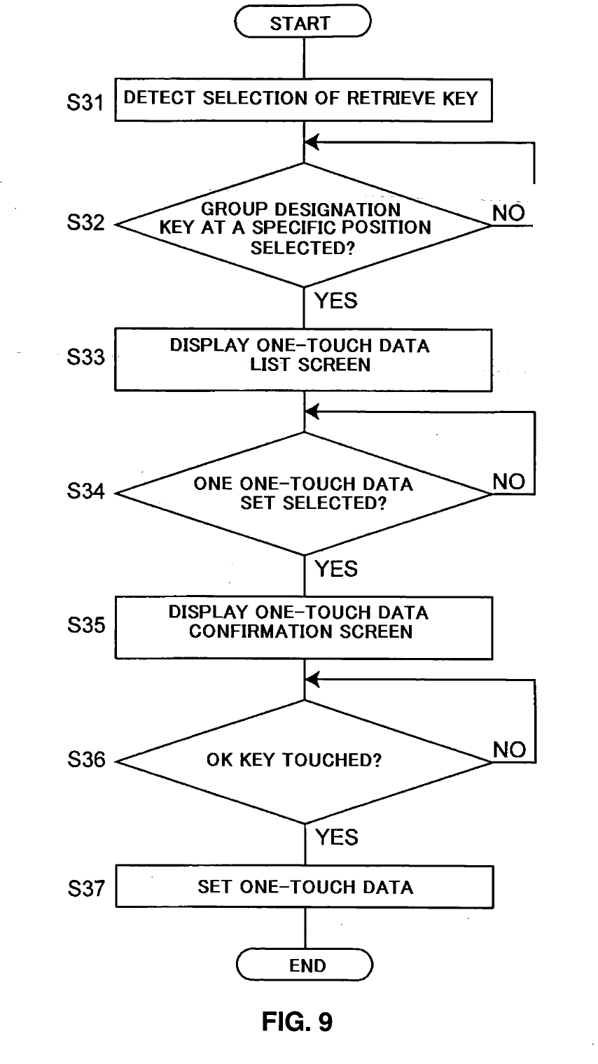

FIG. 9 is a flow chart showing the one-touch data retrieval process carried out using the new one-touch area selection screen of this embodiment. In this process, when it is first detected that the retrieve key 25 is selected (S31), it is determined whether or not a group designation key 32 located at a specific position has been selected (S32). If it is determined that no group designation keys 32 has been selected, the determination of S32 is carried out once more. On the other hand, if it is determined that a group designation key 32 has been selected, a one-touch data list screen as shown in FIG. 5 is displayed (S33).

It is then determined whether or not a one-touch data set has been selected on the one-touch data list screen (S34). If it is determined that no one-touch data set has been selected, the determination of S34 is repeated. On the other hand, if it is determined that a one-touch data set has been selected, a one-touch data confirmation screen is displayed (S35). It is then determined whether or not the OK key 26 has been touched (S36). If it is determined that the key has not been touched, the determination of S36 is carried out once more, while if it is determined that the OK key 26 has been touched, the one-touch data is entered as the settings information to be used (S37), whereupon the process ends.

As described above, by employing the user's tendency to recognize a one-touch area to which one-touch data is registered in terms of positional information on the display panel 20, keys corresponding to groups to which multiple one-touch areas belong (group designation keys 32) are displayed at specific positions on a screen such that a one-touch area can be selected on such screen. Therefore it is not necessary to switch from one screen to another among multiple screens as in the case in which the index-based display specification is used, and a superior user interface can be realized accordingly. In addition, in this embodiment, because the one-touch area selection screen as shown in FIG. 2 and the one-touch area selection screen as shown in FIG. 4 or 6 can be freely alternated taking into consideration users who prefer the conventional one-touch area selection screen of FIG. 2, the desired user interface can be provided to any user.

In this embodiment, in order to realize an even more superior user interface, during new registration, even if no unregistered one-touch area exists with regard to the group designation key 32 selected by the user, it is preferred that a one-touch area be additionally created in connection with such group designation key 32 to the extent possible in order to ensure that the user obtains an unregistered one-touch area.

Accordingly, a process will be described below that comprises the new registration process described above but with the additional feature that even when no unregistered one-touch area exists in connection with the group designation key 32 selected by the user, a one-touch area is additionally created for such group designation key 32, ensuring that the user obtains an unregistered one-touch area. The same numbers are assigned to constituent elements that are identical to those used in the above embodiment, and explanations thereof are therefore omitted.

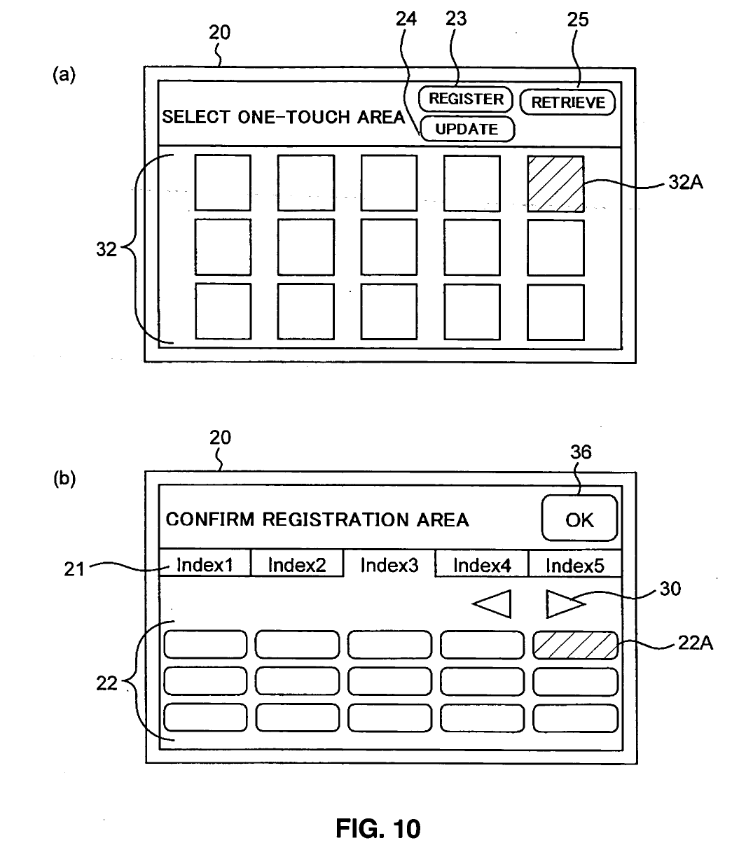

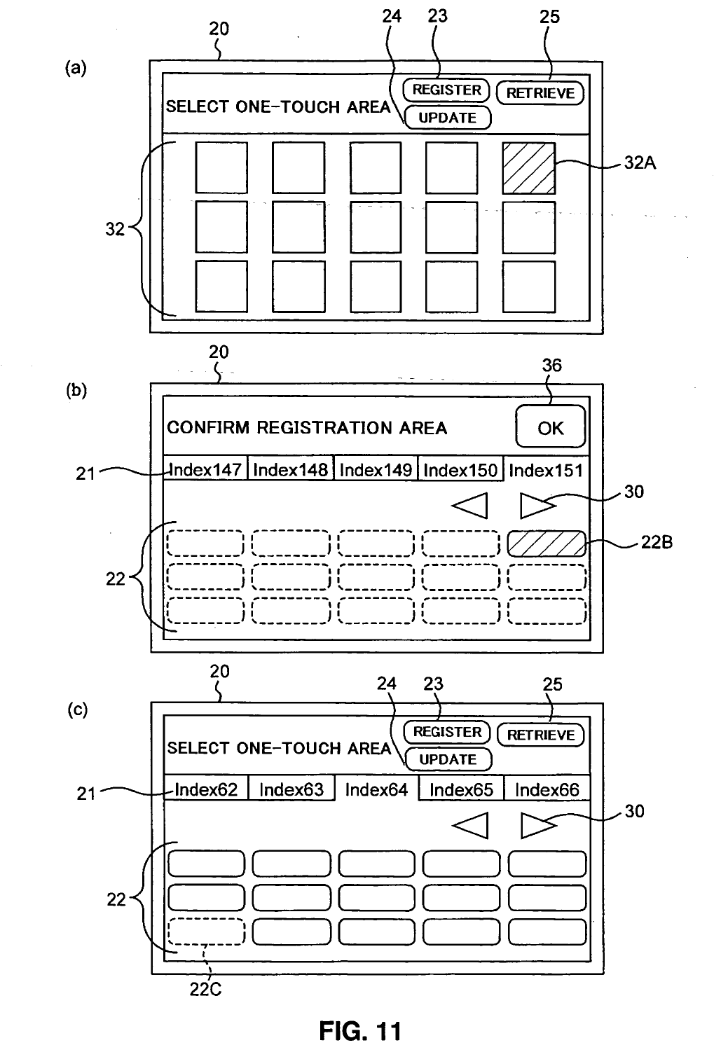

FIGS. 10, 11 and 12 respectively show screens that are displayed on the display panel 20 during new registration when an unregistered one-touch area exists for the selected group designation key 32, when no unregistered one-touch area exists for the selected group designation key 32 but an unregistered one-touch area exists in connection with a different group designation key 32, and when data is already registered to all of the available one-touch areas.

Where an unregistered one-touch area exists in connection with the selected group designation key 32 during new registration, when one of the group designation keys 32 is selected (the group designation key 32A in the upper right-hand corner, i.e., the group designation key 32A at the specific position 5 in this example) on the new one-touch area selection screen as shown in FIG. 10(a), a registration area confirmation screen by which to confirm the one-touch area to which data should be registered is displayed using the index display specification shown in FIG. 10(b). In this registration area confirmation screen, the one-touch area designation key 22A that indicates the one-touch area comprising the registration area is shown via a different display specification from other keys 22 (i.e., using a different pattern or color). Therefore, the user can easily see which one-touch area is to be designated as the registration area. According to the display on the screen shown in FIG. 10(b), it is seen that the one-touch area at the specific position 5 belonging to Index 3, i.e., the one-touch area having the one-touch number X=5+15×(3-1)=35, is selected. When the OK key 36 in the upper right corner of the screen is touched in this state, the settings input screen shown in FIG. 3 is displayed, enabling input of one-touch data by the user.

Where no unregistered one-touch area exists in connection with the selected group designation key 32 but an unregistered one-touch area exists in connection with a different group designation key 32 during new registration, when one of the group designation keys 32 (the group designation key 32A at the specific position 5 in this example) on the one-touch area selection screen as shown in FIG. 11(a) is selected, a registration area confirmation screen by which to confirm the one-touch area to which data should be registered is displayed using the index display specification shown in FIG. 11(b). Before this registration area confirmation screen is displayed, because no unregistered one-touch area exists in connection with the group designation key 32A at the specific position 5, a process is performed to search for unregistered one-touch areas from among the one-touch areas for other group designation keys 32 and set one of these unregistered one-touch areas as a one-touch area for the group designation key 32A. In the initial state of the MFP 1, the number of indices is 150, i.e., the number of one-touch areas for each group designation key 32 is 150, but using this process, when a one-touch area is additionally created in connection with the group designation key 32A selected, an Index 151 and a one-touch area belonging thereto are additionally created. FIG. 11(b) shows the state in which the index tag 21 for the Index 151 is selected. In this state, a one-touch area designation key 22B that corresponds to the additionally created one-touch area is displayed. In FIG. 11(b), one-touch areas corresponding to one-touch area designation keys 22 other than the one-touch area designation key 22B (i.e., the keys 22 indicated using dashed lines) do not exist.

While the Index 151 and a one-touch area belonging thereto are additionally created, a one-touch area belonging to one of the other indices i.e., a different group becomes disabled. Specifically, if the one-touch area corresponding to the one-touch area designation key 22C that belongs to the Index 64 i.e., a different group and is located at the specific position 11 is used for the additionally created one-touch area that belongs to the ‘Index 151’ of the selected group, the one-touch area corresponding to the one-touch area designation key 22C becomes disabled. As a result, in the one-touch area selection screen shown in FIG. 11(c) in which Index 64 is selected, the one-touch area designation key 22C becomes disabled from selection.

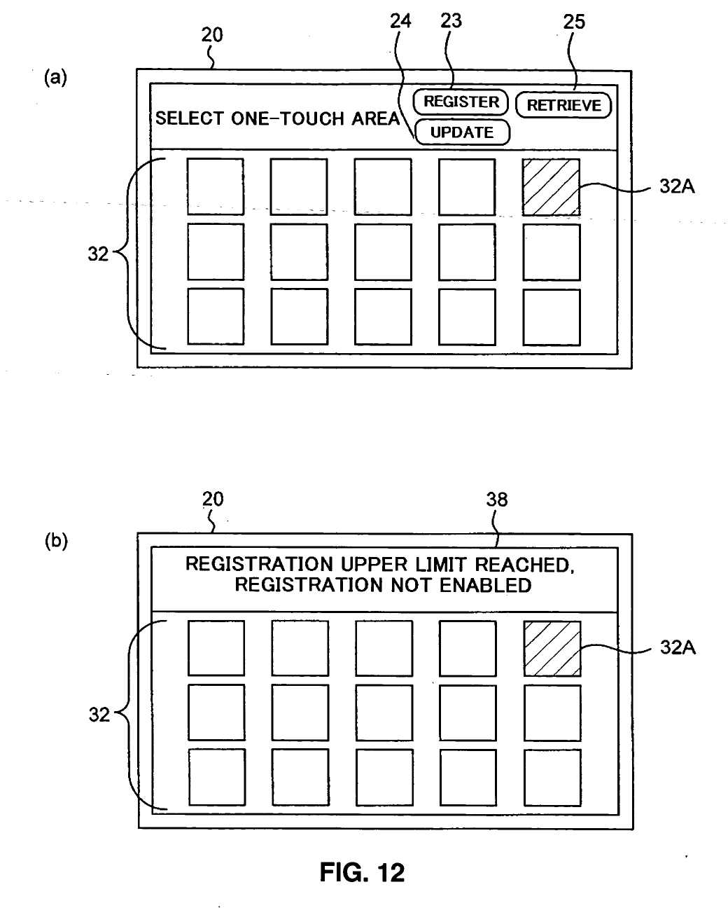

Finally, where new-registration registration has already been completed for all of the available one-touch areas, when one of the group designation keys 32 (the group designation key 32A at the specific position 5 in this example) is selected on the new one-touch area selection screen, as shown in FIG. 12(a), because no unregistered one-touch area exists for the selected group designation key or any other group designation key, it is determined that new registration is not possible, and a message 38 that notifies the user of such fact is displayed as shown in FIG. 12(b).

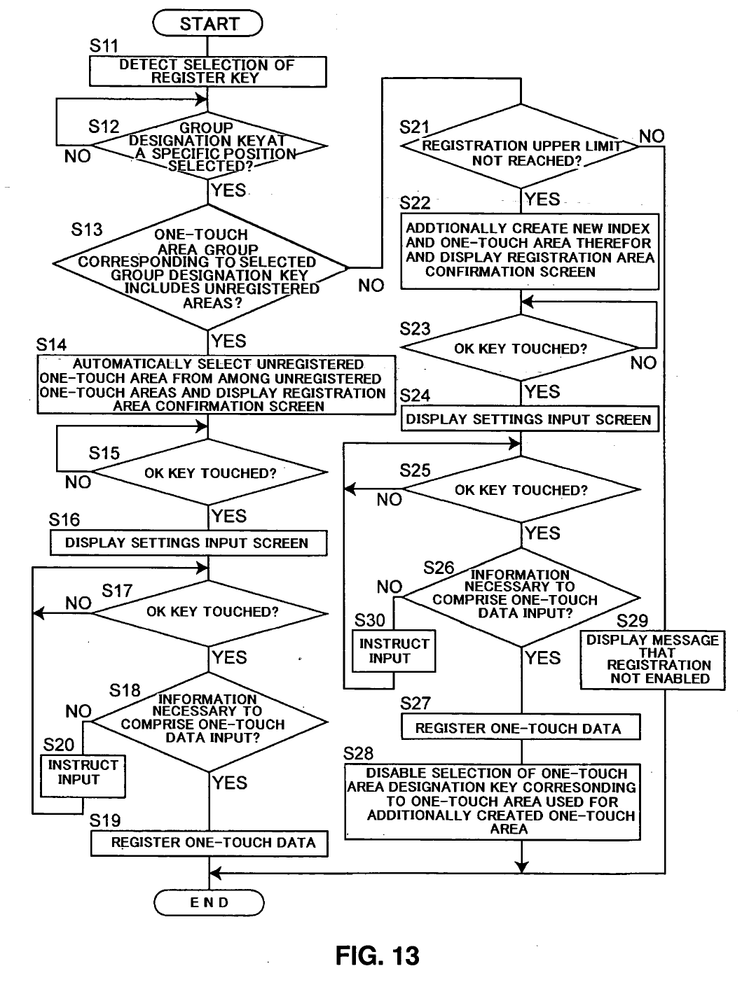

FIG. 13 is a flow chart of the new one-touch data registration process based on the new one-touch area selection screen. In this process, when it is first detected that the register key 23 is selected (S41), it is determined whether or not a group designation key 32 at a specific position is selected (S42). If it is determined that no group designation key 32 is selected, the determination of S42 is carried out once more. On the other hand, if it is determined that a group designation key 32 is selected, it is determined whether or not an unregistered one-touch area exists in the group of one-touch areas corresponding to the selected group designation key 32 (S43).

If it is determined in S43 no unregistered one-touch area exists, S51 is executed. The operation of S51 and the subsequent operations are described below. On the other hand, if it is determined that one or more unregistered one-touch areas exist, one of the unregistered one-touch areas is automatically selected, and a registration area confirmation screen that includes the selected one-touch area is displayed as shown in FIG. 10 (S44). It is then determined whether or not the OK key 36 has been touched (S45). If it is determined that the OK key 36 has not been touched, the determination of S45 is repeated. On the other hand, if it is determined that the OK key 36 has been touched, a settings input screen as shown in FIG. 3 is displayed (S46).

After S46, it is determined whether or not the OK key 36 has been touched (S47). If it is determined that the OK key 36 has not been touched, the determination of S47 is carried out once more, and on the other hand, if it is determined that the OK key 36 has been touched, it is determined whether or not the information necessary to comprise one-touch data has been input in the settings input screen as shown in FIG. 3 (S48). If it is determined that the necessary information has not been input, the user is instructed to perform an input operation via a message prompting input that is displayed on the display panel 20, for example (S50), and S47 is returned to. The operation of S47 as well as the subsequent operations are then repeated. On the other hand, if it is determined in S48 that the necessary information has been input, such information comprising one-touch data is registered (S49), whereupon the process ends.

On the other hand, if it is determined in S43 that no unregistered one-touch area exists, the number of used one-touch areas (i.e., one-touch areas that already contain registered data) is extracted from all indices belonging to all groups, and it is determined whether or not that number equals or exceeds the upper limit (the maximum registration limit) imposed by the limitations of the RAM 4 (S51). If it is determined that the number of used one-touch areas equals or exceeds the registration upper limit, the user is notified via a message displayed on the display panel 20 (S59), for example, that no unregistered one-touch areas exist, i.e., that new registration is not possible, as shown in FIG. 12(b). In this case, the new registration process is discontinued.

On the other hand, if it is determined in S51 that the number of used one-touch areas is below the registration upper limit, a new index and a one-touch area belonging thereto are additionally created, and a registration area confirmation screen shown in FIG. 11(b) is displayed reflecting the additional creations (S52). It is then determined whether or not the OK key 36 has been touched (S53), and if it is determined that the OK key 36 has not been touched, the determination of S53 is carried out once more, while if it is determined that the OK key 36 has been touched, a settings input screen as shown in FIG. 3 is displayed (S54).

After S53, it is determined whether or not the OK key 36 has been touched (S55). If it is determined that the OK key 36 has not been touched, the determination of S55 is carried out once more, while if it is determined that the OK key 36 has been touched, it is determined whether or not the information necessary to comprise one-touch data has been input in the settings input screen as shown in FIG. 3 (S56). If it is determined that the necessary information has not been input, the user is instructed to perform an input operation via a message prompting input that is displayed on the display panel 20, for example (S60), and S55 is returned to. The operation of S55 as well as the subsequent operations are then repeated. On the other hand, if it is determined in S56 that the necessary information has been input, such information comprising one-touch data is registered (S57). Furthermore, in order to disable the use of the unregistered one-touch area used for the additional creation of an index and the one-touch area belonging thereto in S52, the one-touch area designation key corresponding to such one-touch area is disabled for selection (S58), as shown in FIG. 11(c), whereupon the process ends.

As described above, although the process described above is possible only so long as the registration upper limit of the memory (RAM 4) that stores one-touch data is not exceeded, by ensuring the creation of a one-touch area to which one-touch data can be registered for a group designation key 32 at a specific position selected by the user, the user can very easily select a one-touch area and a superior user interface can be realized. In addition, in this case, it is not necessary for the user to re-select a group designation key 32 at a specific position on the one-touch area selection screen as shown in FIG. 4, enabling the user tendency to recognize one-touch data registration areas (one-touch areas) in terms of positional information on the display panel 20 to be more effectively utilized.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

For example, in the embodiment described above, the process by which to select a one-touch area during one-touch data new registration, update registration and retrieval operations was described, but the application of the present invention is not limited to these operations, and a one-touch data list screen as shown in FIG. 5 may be displayed upon the selection of a group designation key 32 in the same manner as for update registration and retrieval operations to enable selection of one-touch data for a one-touch data deletion operation.

In the embodiment described above, the specific positions on the display panel 20 were arranged according to a 3×5 matrix, but the present invention is not limited to this implementation, and the specific positions may be arranged in any way and comprise any number. The applies to the one-touch area designation keys 22 and group designation keys 32 assigned to a specific position as well.

In the embodiment described above, a description was provided based on a situation in which one-touch data new registration, update registration and retrieval operations are carried out using the operation unit 5 of the MFP 1, but the present invention is not limited to this implementation. The present invention may be applied when operations are carried out using an external terminal (not shown) connected to the MFP 1 by displaying the new one-touch area selection screen on the display screen of the external terminal.

In the embodiment described above, an unregistered one-touch area to be used as an additionally created one-touch area was automatically selected, but it is also acceptable if such one-touch area is user-selected instead.

In the embodiment described above, each of the multiple index tags 21 has a screen containing one-touch area designation keys 22 comprising multiple options assigned to predetermined positions and these one-touch area selection keys 22 are located at the same positions throughout the multiple indices, but it is acceptable if the positions of the one-touch areas are slightly or completely different from one index to another. In addition, it is preferred that the multiple one-touch area designation keys 22 that are displayed when an index tag 21 is selected be arranged such that they do not overlap.

1. A user interface device, comprising:
a display that displays a plurality of first selection screens, each of which includes a plurality of options positioned at predetermined positions, alternatively;
a position designation unit that designates a position of an option; and
a display controller that controls the display so that a second selection screen is displayed on the display, wherein the second selection screen includes options located at the position designated by the position designation unit in each of the plurality of the first selection screens.

2. The user interface device according to claim 1, further comprising
a selection unit that selects a desired option, which is at least one of the options of the second selection screen.

3. The user interface device according to claim 2, wherein the display controller controls the display so that when the desired option is selected by the selection unit, a settings information corresponding to the desired option is displayed on the display.

4. The user interface device according to claim 1, further comprising,
a storage unit that stores settings information in connection with each of the plurality of the options.

5. The user interface device according to claim 1, further comprising,
a storage unit that stores settings information in connection with each of the plurality of the options, and
a selection unit that selects a desired option, which is at least one of the options of the second screen,
wherein the display controller control the display so that the settings information corresponding to the desired option selected by the selection unit is displayed on the display.

6. The user interface device according to claim 5, further comprising
an update unit that updates the settings information corresponding to the desired option displayed by the display controller.

7. The user interface according to claim 5, wherein for selecting the desired option the user interface has a first mode in which the desired option is selected from the first selection screen and a second mode in which the desired option is selected from the second selection screen.

8. The user interface device according to claim 5, wherein the display controller controls the display so that a position designation screen which represented the number of options or a graphic symbol representing such number at the position corresponding to each position of the plurality of options included in each selection screens located therein is displayed on the display, and
wherein the position designation unit designates a position of the option form the position designation screen.

9. A user interface device, comprising:
a display that displays a plurality of fist selection screens, each of which includes a plurality of options positioned at predetermined positions, alternatively;
a storage unit that stores settings information in connection with each of the plurality of the options,
a position designating unit that designates a position of an option,
a display controller that controls the display so that a input screen, which is accepted the registration of new settings information in connection with the non-registration option, is displayed on the display, wherein the non-registration option is one of the options which is located at the position designated by the position designation unit in each of the plurality of the selection screens, and to which the settings information in connection with the non-registration option is not registered in the storage unit; and
an input unit for inputting the new settings information in the input screen.

10. A user interface device, comprising:
a display that displays a plurality of first selection screens, each of which includes a plurality of options positioned at predetermined positions, alternatively;
a storage unit that stores settings information in connection with each of the plurality of the options;
a mode selecting unit that selects either a registration mode for the registration of new settings information or a confirmation mode for confirming already registered settings information;
a position designation unit that designates the position of a option,
a display controller that controls the display, so that a second selection screen, which includes options located at the position designated by the position designation unit in each of the plurality of the first selection screen, is displayed on the display, in a case where the registration mode is selected, and so that a input screen, which is accepted the registration of new settings information in connection with the non-registration option, is displayed on the display, in a case where the registration mode is selected, wherein the non-registration option is one of the options which is located at the position designated by the position designation unit in each of the plurality of the selection screens, and to which the settings information in connection with the non-registration option is not registered in the storage unit;
an input unit for inputting the new settings information in the input screen, and
a selection unit that selects a desired option, which is at least one of the options of the second screen;
wherein the display controller controls the display so that when the desired option is selected by the selection unit, a settings information corresponding to the desired option is displayed on the display.

11. A user interface device, comprising:
a display that displays a plurality of selection screens, each of which includes a plurality of options positioned at predetermined positions, alternatively;
a storage unit that stores settings information in connection with each of the plurality of the options; and
a display controller that controls the display so that a position designation screen which represented the number of options or a graphic symbol representing such number at the position corresponding to each position of the plurality of options included in each selection screens located therein is displayed on the display.

12. A user interface device, comprising:
a display that displays a plurality of selection screens, each of which includes a plurality of options positioned at predetermined positions, alternatively;
a storage unit that stores settings information in connection with each of the plurality of the options,
a position designating unit that designates a position of an option, and
a display controller that controls the display so that a registration confirmation screen is displayed on the display, wherein the registration confirmation screen corresponds to a selection screen that includes a non-registration option located at the position designated by the position designation unit and the settings information in connection with the non-registration option is not registered in the storage unit.

13. The user interface device according to claim 12, wherein when settings information is registered in connection with all of the options, which is located at the position designated by the position designation unit, in the plurality of selection screens, the registration confirmation screen corresponds to a new selection screen different from the plurality of selection screens.

14. The user interface device according to claim 13, further comprising:
an approval unit that approves the non-registration option displayed on the registration confirmation screen when the non-registration option is acceptable for the registration of settings information; and
an input unit by which to input settings information for registration,
wherein when approval is input by the approval input unit, the display controller performs control so that a settings input screen that accepts new registration information is displayed on the display.

15. A user interface device, comprising:
a display that displays a plurality of selection screens, each of which includes a plurality of options positioned at predetermined positions, alternatively;
a storage unit that stores settings information in connection with each of the plurality of the options,
an input unit by which to input settings information for registration,
a position designating unit that designates a position of an option, and
a controller that controls so that the settings information inputted by the input unit is stored in connection with the non-registration option, when the non-registration option, which is located at the position designated by the position designation unit and to which the settings information is not registered, exists and so that the settings information inputted by the input unit is stored in connection with a new option in a new selection screen, when all of the options in the plurality of selection screens located at the position designated by the position designation unit have registered settings information.

16. The user interface device according to claim 15, wherein the display is controlled so that where the settings information is registered with the option in a new selection screen, the plurality of selection screens including the new selection screen are displayed in an alternating fashion.

17. The user interface device according to claim 15, further comprising:
a mode selection unit for selecting a first mode and a second mode,
wherein the first selection mode in which a desired option is selected from among the options in the plurality of selection screens located at the position designated by the position designating unit, and
wherein the second selection mode in which a desired option is selected from among the options displayed in a desired selection screen displayed by switching among the plurality of selection screens.

18. An image forming apparatus, comprising:
a display that displays a plurality of selection screens, each of which includes a plurality of options positioned at predetermined positions, alternatively;
a position designation unit that designates a position of an option;
a display controller that controls the display so that a second selection screen is displayed on the display, wherein the second selection screen includes options located at the position designated by the position designation unit in each of the plurality of the first selection screens.
